(19) United States
(12) Patent Application Publication
(10) Pub. No.: US 2002/0050056 A1
(43) Pub. Date: May 2, 2002

(54) Device for fixing the main metal in the drive unit

(75) Inventor: Yongda Chen, Shenzhen (CN)

Correspondence Address: LOWE HAUPTMAN GOPSTEIN, GILMAN AND BERNER LLP, SUITE 310, 1700 DIAGONAL ROAD, ALEXANDRIA, VA, 22314

(73) Assignee: Valley Wood Ltd.

(21) Appl. No.: 09/983,361

(22) Filed: Oct. 24, 2001

(30) Foreign Application Priority Data
Nov. 2, 2000 (CN) 00257408.X

(51) Int. Cl. B23P 19/00

(52) U.S. Cl. 29/650

(57) ABSTRACT

The present utility model belongs to domestic appliances, especially to devices for fixing the main metal in the drive unit of tape recorders, video players or cameras. A main base 2 with a main base bore is fixed on a chassis 50 with a chassis bore by screw 4. A step-shaped metal 3 is inserted inside a bore formed by the main base bore and the chassis bore, and on the metal positioning plane 3-1. A shaft 5 is planted inside the step-shaped metal 3. A washer 1 is installed at one end of the shaft 5. The metal, the chassis and the main base are positioned against each other vertically and horizontally. In such pattern, any ill effect of the declination of the metal has been prevented, in consideration of the case that tape recorder, video player, or camera falls onto the ground, so that the normal operation of the appliances is ensured.

The present utility model belongs to domestic appliances, especially to devices for fixing the main metal in the drive unit of tape recorders, video players or cameras.

The drive unit of the tape recorders, video players or cameras comprises various kinds of parts. These parts form some devices with different functions, such as driving devices, retarding devices, and electric controlled devices. In the driving devices of the drive unit, a device is used to fix the main metal in the drive unit of the tape recorders, video players or cameras. This device has an elastic. “┐”-shaped positioning part 50-1 on the chassis 50, by which the metal 3 can be tightened on the chassis (See FIG. 3), so as to position the metal. But in the tape recorders, video players or cameras, metal-positioning parts adopted in prior art are not sufficiently intensive, the “┐”-shaped positioning part on the chassis of the drive unit can easily be distorted by strong impact, for example when the appliances fall on to the ground from a higher place, so that the metal will be declined due to the distortion, therefor the tape recorder, video player or camera cannot operate normally.

The objective of the present utility model is to provide a new device for fixing the main metal in the drive unit, and to overcome the disadvantage of the device for fixing the main metal in the drive unit used in the prior art for tape recorders, video players or cameras, in that the positioning part of the metal can be easily distorted due to strong impact.

The objective of the present utility model is achieved according to the followings:

The present utility model includes a chassis with a chassis bore, a main base with a main base bore, a metal and a shaft, wherein, the main base 2 is fixed on the chassis 50 by screw 4. A step-shaped metal 3 is inserted inside a bore formed by the main base bore and the chassis bore on the metal positioning plane 3-1. A shaft 5 is planted inside the step-shaped metal 3. A washer 1 is installed at one end of the shaft 5.

The said metal positioning plane 3-1 is a part of the chassis 50 formed by the diameter difference of the main base bore and the chassis bore.

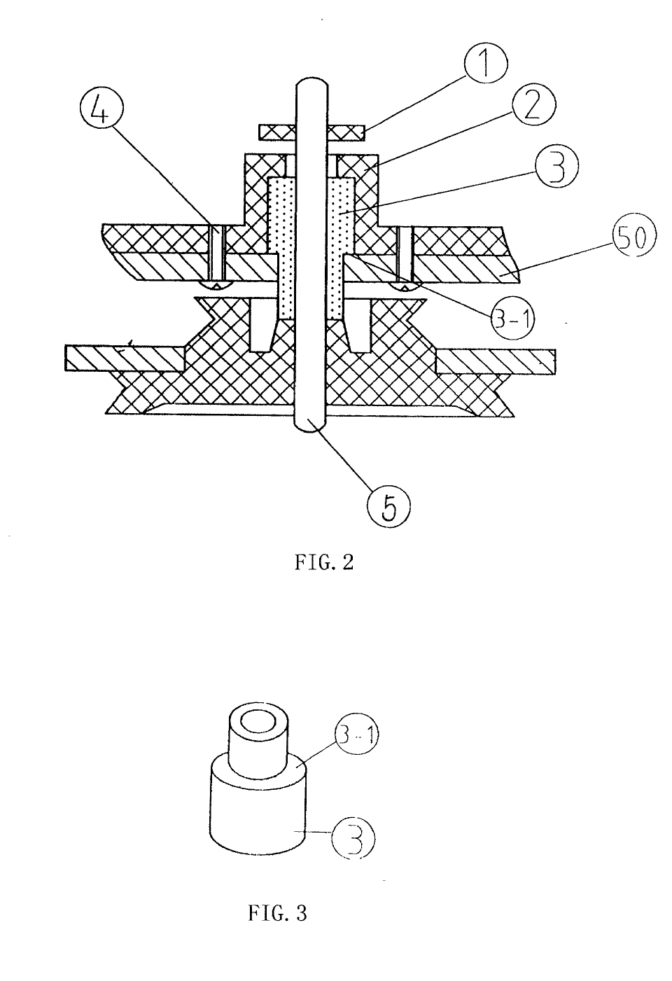

Since the main base 2 and the chassis 50 of the present utility model are fixed together by the screw 4 (See FIG. 2), such that the metal, chassis, and the main base are positioned against each other vertically and horizontally. In such intensive design of metal-positioning, the metal can be prevented from declination produced when the tape recorder, video player, or camera falls on to the ground from a higher place, and the operation of the appliance is ensured to keep in normal.

The following is a further description of the technical scheme of the present utility model in connection with the appended figures and the embodiment.

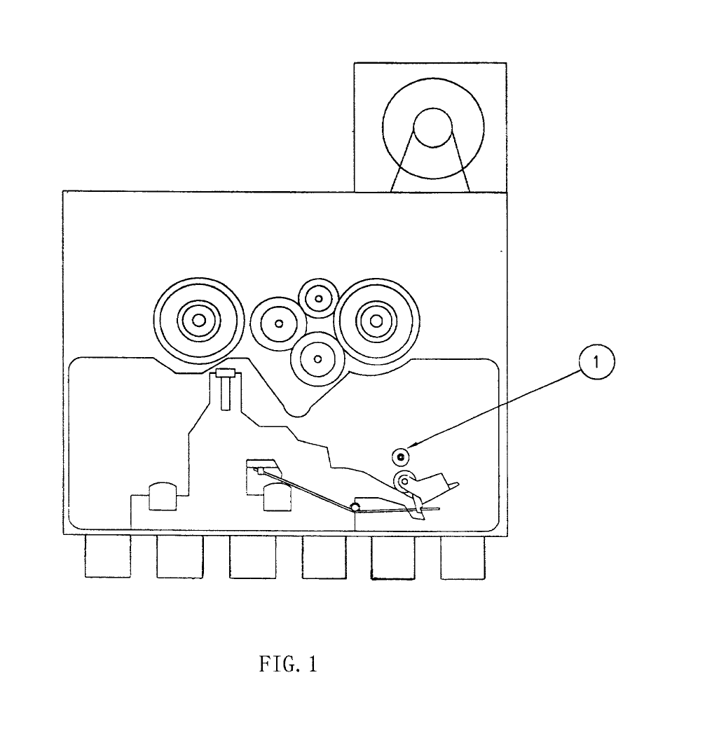

FIG. 1 is an overall schematic view of the present utility model after assembly;

FIG. 2 is a longitudinal section schematic view of the present utility model;

FIG. 3 is a schematic view of the main metal of the present utility model;

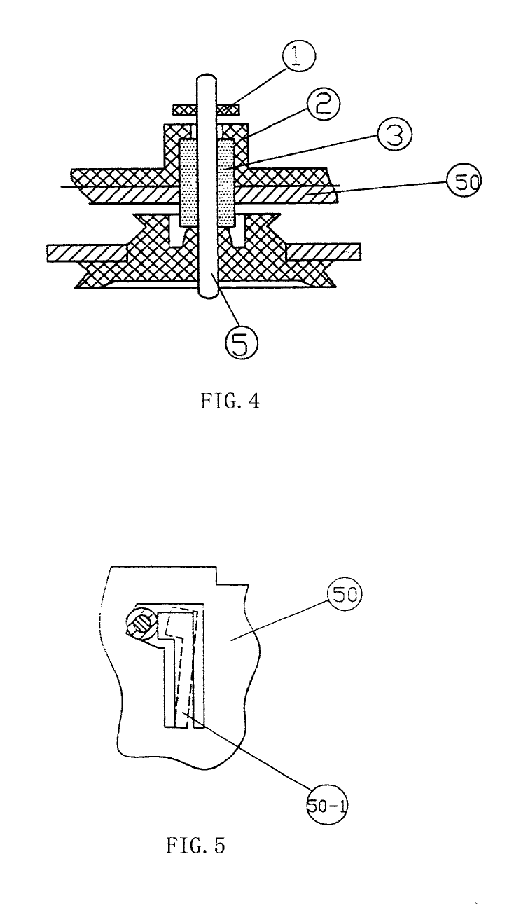

FIG. 4 is a longitudinal section schematic view of the device for fixing main metal for tape recorders, video players or cameras in prior art;

FIG. 5 is a schematic view of the positioning part for tightening the metal on the chassis of tape recorders, video players or cameras in prior art;

1. Washer 2. Main base 3. Metal 3-1. Metal positioning plane

4. Screw 5. Shaft 50. Chassis 50-1. Positioning part

A preferred embodiment is introduced:

In FIGS. 2 & 3, on the chassis 50 of a tape recorder, a main base 2 is fixed by screw 4, the metal positioning plane 3-1 is part of the chassis and formed by the main base bore and the chassis bore. A step-shaped metal 3 is located on the metal positioning plane 3-1. The shaft 5 is firmly installed inside the step-shaped metal 3. At one end of the shaft 5 extending out of the main base 2, a washer 1 is mounted. FIG. 1 is an overall schematic view of the present utility model after assembly. Such a intensive metal-positioning design can prevent declination of the metal when the tape recorder, video player, or camera falls onto the ground from a higher place, and the operation of the appliance is ensured to keep in normal.

While this utility model has been described with reference to the figures and embodiments, it will be understood that various changes within the spirit and scope of this utility model as defined by the appended claims are effected.

1. A device for fixing the main metal in the drive unit, including a chassis with a chassis bore, main base with a main base bore, a metal and a shaft, wherein,
a main base (2) is fixed on the chassis (50) by screw (4);
a step-shaped metal (3), is inserted inside a bore formed by the main base bore and the chassis bore, and on the metal positioning plane (3-1);
a shaft (5) is planted inside the step-shaped metal (3);
a washer (1) is installed at one end of the shaft (5).

2. The device for fixing the main metal in the drive unit according to the claim 1, wherein, the said metal positioning plane (3-1) is a part of the chassis and formed by the diameter difference of the main base bore and the chassis bore.
